(19) United States
(12) Patent Application Publication
(10) Pub. No.: US 2024/0006346 A1
(43) Pub. Date: Jan. 4, 2024

(54) METAL-INSULATOR-METAL CAPACITOR (MIMCAP)-BASED PHYSICALLY UNCLONABLE FUNCTION

(71) Applicant: International Business Machines Corporation, Armonk, NY (US)

(72) Inventors: Cheng Chi, Jersey City, NJ (US); Takashi Ando, Eastchester, NY (US); REINALDO VEGA, Mahopac, NY (US); Praneet Adusumilli, Somerset, NJ (US)

(21) Appl. No.: 17/854,125

(22) Filed: Jun. 30, 2022

(51) Int. Cl. H01L 23/00

(52) U.S. Cl. CPC H01L 23/573

(57) ABSTRACT

An integrated circuit includes a semiconductor substrate; a logic area, located outward of the semiconductor substrate; and a physically unclonable function (PUF) area, located outward of the semiconductor substrate. The logic area includes a plurality of logic metal-insulator-metal decoupling capacitors with at least three plates. The PUF area includes a plurality of PUF metal-insulator-metal capacitors with at least three plates. Shorts and opens are avoided in the logic area, while the PUF metal-insulator-metal capacitors exhibit deliberately-introduced shorts and opens that function as a PUF.

### BACKGROUND

The present invention relates generally to the electrical, electronic and computer arts and, more particularly, to supply chain integrity for integrated circuits (ICs).

A physical unclonable function (sometimes also called a physically unclonable function), or PUF, is a physically defined “digital fingerprint” that serves as a unique identity for a semiconductor device such as a microprocessor. In current IC applications, most PUFs are based on unique physical variations which occur naturally during semiconductor manufacturing.

Semiconductor supply chain integrity is a pertinent consideration; it is desirable to verify that chips installed in important systems are authentic. For example, counterfeit components, if substituted for real ones, can contain malicious circuitry enabling loss of functionality or snooping. Some current semiconductor manufacturing techniques employ so-called “split manufacturing” where front-end-of-line (FEOL) fabrication takes place in a first foundry, while back-end-of-line (BEOL) fabrication takes place in a second foundry. A number of prior art PUF approaches utilize features in the FEOL, such as static random-access memories (SRAM)) features or non-volatile memory (NVM) layers (e-fuse) features. As will be appreciated by the skilled artisan, an e-fuse (electronic fuse) is a microscopic fuse put into a computer chip, to allow for the dynamic real-time reprogramming of chips. Typically, computer logic is hard-wired onto a chip and cannot be changed after the chip has finished being manufactured; however, by utilizing a set of e-fuses, a chip manufacturer can allow for the circuits on a chip to change while it is in operation.

### BRIEF SUMMARY

Principles of the invention provide techniques for a metal-insulator-metal capacitor (MIMCAP)-based physically unclonable function. In one aspect, an exemplary integrated circuit includes a semiconductor substrate; a logic area, located outward of the semiconductor substrate, the logic area including a plurality of logic metal-insulator-metal decoupling capacitors; and a physically unclonable function (PUF) area, located outward of the semiconductor substrate, the PUF area including a plurality of PUF metal-insulator-metal capacitors. Each of the logic metal-insulator-metal decoupling capacitors includes an upper logic area capacitor electrically conductive plate; a middle logic area capacitor electrically conductive plate; a lower logic area capacitor electrically conductive plate; an upper logic area capacitor dielectric region separating the upper logic area capacitor electrically conductive plate from the middle logic area capacitor electrically conductive plate; a lower logic area capacitor dielectric region separating the middle logic area capacitor electrically conductive plate from the lower logic area capacitor electrically conductive plate; a top-bottom logic area capacitor electrical contact electrically coupled to the upper logic area capacitor electrically conductive plate and the lower logic area capacitor electrically conductive plate, and electrically isolated from the middle logic area capacitor electrically conductive plate; and a middle logic area capacitor electrical contact electrically coupled to the middle logic area capacitor electrically conductive plate and electrically isolated from the lower logic area capacitor electrically conductive plate and the upper logic area capacitor electrically conductive plate. Each of the PUF metal-insulator-metal capacitors includes an upper PUF area electrically conductive plate; a middle PUF area electrically conductive plate; a lower PUF area electrically conductive plate; an upper PUF area dielectric region separating the upper PUF area electrically conductive plate from the middle PUF area electrically conductive plate; a lower PUF area dielectric region separating the middle PUF area electrically conductive plate from the lower PUF area electrically conductive plate; a top-bottom PUF area electrical contact; and a middle PUF area electrical contact. At least 10% of the PUF metal-insulator-metal capacitors and no more than 90% of the PUF metal-insulator-metal capacitors exhibit shorts.

In another aspect, a hardware description language (HDL) design structure is encoded on a machine-readable data storage medium, and the HDL design structure includes elements that when processed in a computer-aided design system generates a machine-executable representation of an apparatus/circuit. The HDL design structure includes an integrated circuit as just described.

In still another aspect, an exemplary method includes obtaining a precursor semiconductor structure including a substrate, and a device layer outside of the substrate; and obtaining a plurality of photomasks, including at least one via photomask with a logic area and a physically unclonable function (PUF) area. A logic via pattern in the logic area complies with design rules for a given technology node and a PUF via pattern in the PUF area violates design rules for the given technology node. A further step includes, using the plurality of photomasks, including the at least one via photomask, lithographically forming on the precursor semiconductor structure, in accordance with the given technology node a logic area, formed at least in part using the logic area of the at least one via photomask, and located outward of the semiconductor substrate, and a physically unclonable function (PUF) area, formed at least in part using the PUF area of the at least one via photomask, located outward of the semiconductor substrate. The logic area includes a plurality of logic metal-insulator-metal decoupling capacitors, as described above. The PUF area includes a plurality of PUF metal-insulator-metal capacitors, as described above. At least 10% of the PUF metal-insulator-metal capacitors and no more than 90% of the PUF metal-insulator-metal capacitors exhibit shorts.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
enhanced IC security using a PUF that can be added without requiring additional processes, by introducing a PUF region in a BEOL decoupling MIMCAP module that is already present and being used for logic purposes;
a solution that is implementable even in 7 nm and smaller technology nodes (applicable to larger nodes as well, if desired) without changing the integration flow for BEOL MIMCAPs (in one or more embodiments, no change needs to be made to the existing integration flow other than perturbing one or more lithographic masks to use different rules in a PUF area as opposed to a logic area).

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows a three-plate metal-insulator-metal capacitor (MIMCAP), as known from the prior art.

FIG. 2 shows an integrated circuit, according to an aspect of the invention, with a conventional logic three-plate MIMCAP region and a three-plate MIMCAP PUF region.

FIG. 3A is a side view of a three-plate MIMCAP PUF region, according to an aspect of the invention, showing pertinent dimensions.

FIG. 3B is a plan view looking up along line III-B in FIG. 3A, according to an aspect of the invention, showing pertinent dimensions.

FIG. 4 shows how via size variation can be achieved by sub-resolution assistant feature (SRAF) placement on a lithographic mask, according to an aspect of the invention.

FIG. 5A is a side view of an integrated circuit, according to an aspect of the invention.

FIG. 5B is a plan view, along line section line V-B of FIG. 5A, according to an aspect of the invention.

FIG. 6 depicts a computer system that could implement a design process such as that shown in FIG. 7).

FIG. 7 is a flow diagram of a design process used in semiconductor design, manufacture, and/or test.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

As noted, some current semiconductor manufacturing techniques employ so-called “split manufacturing” where front-end-of-line (FEOL) fabrication takes place in a first foundry, while back-end-of-line (BEOL) fabrication takes place in a second foundry. As also noted, a number of prior art PUF approaches utilize features in the FEOL. However, for PUF implemented in the FEOL, the second foundry may not be comfortable. One or more embodiments advantageously allow PUF to be implemented in the BEOL by the second foundry.

One or more embodiments provide a simple, yet highly effective, PUF structure in BEOL MIMCAPs, and a fabrication method that leverages the inherent randomness of the lithography process. Advantageously, in one or more embodiments, no additional processes are needed to embed the PUF into complementary metal oxide semiconductor (CMOS) logic. In one or more embodiments, the BEOL MIMCAP is integrated at high levels in the BEOL, so that interference with CMOS logic circuits can be readily avoided. One or more embodiments are applicable to multi-plate (more than two plates) BEOL MIMCAPs for on-chip decoupling capacitors, which is the industry standard for the 14 nm-node and smaller. In one or more embodiments, opens and shorts of vias to plates in BEOL MIMCAPs occur in a random manner in the PUF area of the chip, whereas vias to plates are always isolated in the logic area. In one or more embodiments, the open and short feature is used as a unique identifier (ID) of the chip.

Advantageously, one or more embodiments enhance the security of the chip and are implementable even in 7 nm and smaller technology nodes without changing the integration flow for BEOL MIMCAPs (note that one of more embodiments could be implemented in larger technology nodes as well).

In one or more embodiments, a BEOL MIMCAP has multiple plates, and the MIMCAPs and PUF are provided on the same BEOL wiring level. There are different via to non-contacted electrode plate distances for the MIMCAP and PUF areas. The via to non-contacted electrode distance follows the design rule of the technology in the MIMCAP area, while the via to non-contacted electrode distance is within the variation of via size in the PUF area. There is a larger variation in via size and/or shape in the PUF area, and there is also a larger variation in via to plate shorts in the PUF area.

Furthermore, one or more embodiments use different sub-resolution assistant feature (SRAF) placements in the MIMCAP and PUF areas to cause vias in the PUF area to be more susceptible to process-induced variability than those in the MIMCAP area. In one or more embodiments, lithographic process conditions are optimized to introduce a large variability in via size and/or shape in the PUF area, while keeping vias in the MIMCAP area uniform.

In one or more embodiments, a via size near the lithographic limit is used in the PUF area to introduce a larger variability.

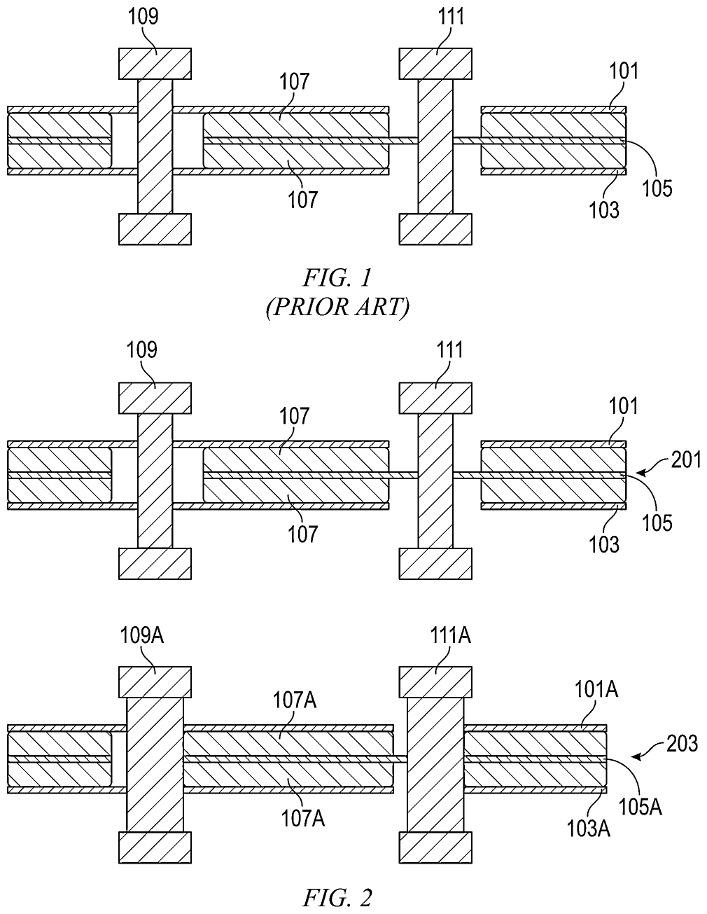

FIG. 1 shows a multi-plate (more than two plates) BEOL MIMCAP employed as an on-chip decoupling capacitor, according to the prior art. Note the top metal 101, bottom metal 103, middle metal 105, MIM dielectric 107, top/bottom contact 109 electrically connected to the top metal 101 and bottom metal 103, and the middle contact 111 electrically connected to the middle metal 105.

FIG. 2 shows multi-plate (more than two plates) BEOL MIMCAPs employed as on-chip decoupling capacitors in a decoupling capacitor area 201 of the chip, as well as BEOL MIMCAPs employed in a PUF area of the chip 203. The BEOL MIMCAPs employed as on-chip decoupling capacitors in the decoupling capacitor area 201 of the chip are essentially the same as in the prior art view of FIG. 1. In the PUF area of the chip 203, note the top metal 101A, bottom metal 103A, middle metal 105A, MIM dielectric 107A, top/bottom contact 109A, and the middle contact 111A. In the example of FIG. 2, as discussed further elsewhere herein, the contacts 109A, 111A are deliberately made larger than the contacts 109, 111, and the vias in which the contacts 109A, 111A are located are deliberately made smaller than the vias in which the contacts 109, 111 are located. As used herein, the “vias” are the openings in which the contacts 109, 111, 109A, 111A are located.

Furthermore in this regard, consider BEOL MIMCAP mask design. In the decoupling capacitor area 201, follow the via enclosure rule for designs of via placement to one of the electrodes and the other electrode plates. On the other hand, in the PUF area 203, deliberately violate the via enclosure rule to make the distance between the via and other electrode plates within the process variation. Furthermore, in one or more embodiments, use a via size close to the process limit for the PUF area 203 while the standard via size is used in decoupling capacitor area 201. In one or more embodiments, the integration flow includes formation of multiple-plate MIMCAP stacks; inter-layer dielectric (ILD) deposition and planarization; optional via lithography process with process-induced variability; and via contact formation for each electrode plate. Thus, one or more embodiments use SRAF to cause vias in the PUF area 203 more susceptible to process-induced variability. In some cases, lithography process conditions are optimized to introduce a large variability in via size and/or shape in the PUF area 203, while keeping the vias in the decoupling capacitor area 201 uniform.

Regarding exemplary structure, one or more embodiments include BEOL MIMCAP 201 with multiple plates 101, 103, 105; with different via to non-contacted electrode plate distances for the decoupling capacitor 201 and PUF 203 areas. A larger variation in via size and/or shape is seen in the PUF area 203; a consequence of this is a larger variation in via-to-plate shorts in the PUF area.

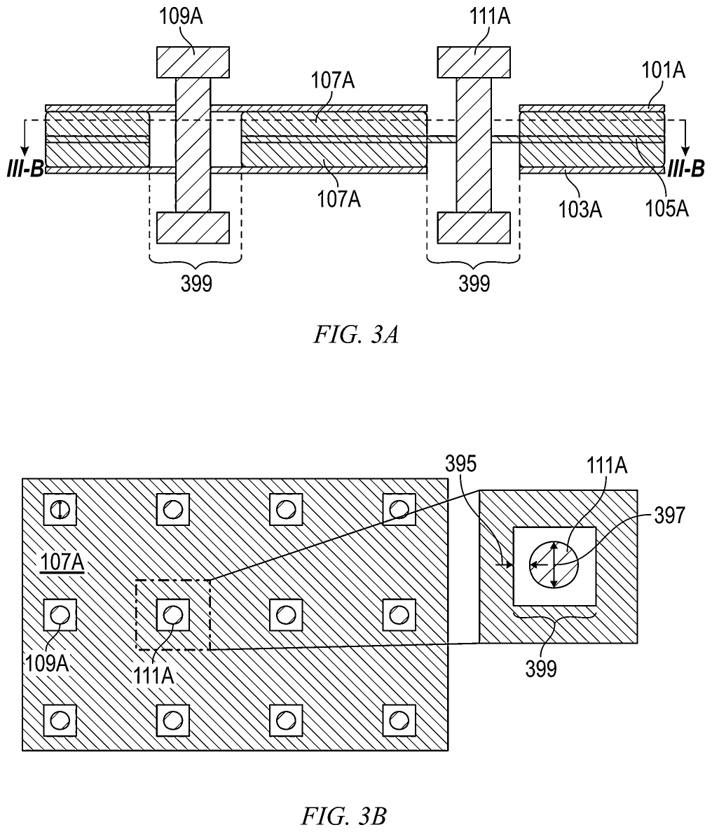

FIG. 3A is a side view of a PUF area similar to PUF area 203, and also showing the width 399 of generally square vias for the top/bottom contacts 109A, and the middle contacts 111A. FIG. 3B is a plan view looking up along line III-B in FIG. 3A. FIGS. 3A and 3B illustrate exemplary techniques for achieving larger variation in the via open/short distribution. In order to achieve a larger open/short distribution for the PUF area, a larger variation of via size 399 and/or marginal overlay is appropriate. Two pertinent design parameters include: (1) distance from middle contact 111A to upper and lower metal plates 101A, 103A; and (2) middle via size 399. In a non-limiting example, the middle via and the upper/lower via may be designed to have the same nominal size. There may be a larger variation from via-to-via in the PUF area as compared to the logic area. It is possible to determine the distance 395 between the contact 111A and the metal plate using, for example, foundry-provided process conditions. Note also the middle contact diameter 397.

With regard to the marginal overlay, the skilled artisan will appreciate that overlay refers to the pattern-to-pattern alignment in successive fabrication stages. For example, in the MIMCAP example, overlay impacts how the via lands on the metal area. In lithographic patterning, there is typically always some slight offset which determines how the contact lands to the metal; for example, shifter right, shifted left, or “right on.” In one or more embodiments, while overlay is not deliberately introduced, the PUF area is deliberately located in regions of the chip likely to have effects from marginal patterning overlay. Thus, in one or more embodiments, randomness is introduced into the PUF area by critical dimension (CD) control and also by the way the contact lands on the metal/device—right on the center or shifted. As discussed elsewhere herein, in some cases, CD is controlled using sub-resolution assistant feature (SRAF) placement.

Given the teachings herein, the skilled artisan will be able to calculate the distance between the via and the metal based on the process conditions (e.g., critical dimension (CD)) provided by the foundry; for example, depending on whether extreme ultraviolet (EUV) patterning techniques or deep ultraviolet (DUV) patterning techniques are employed. For example, initial calculations can provide a range of starting distances 395 between the contact and the MIM plate to start and can further determine the dimensions of the MIM-cap in the PUF design.

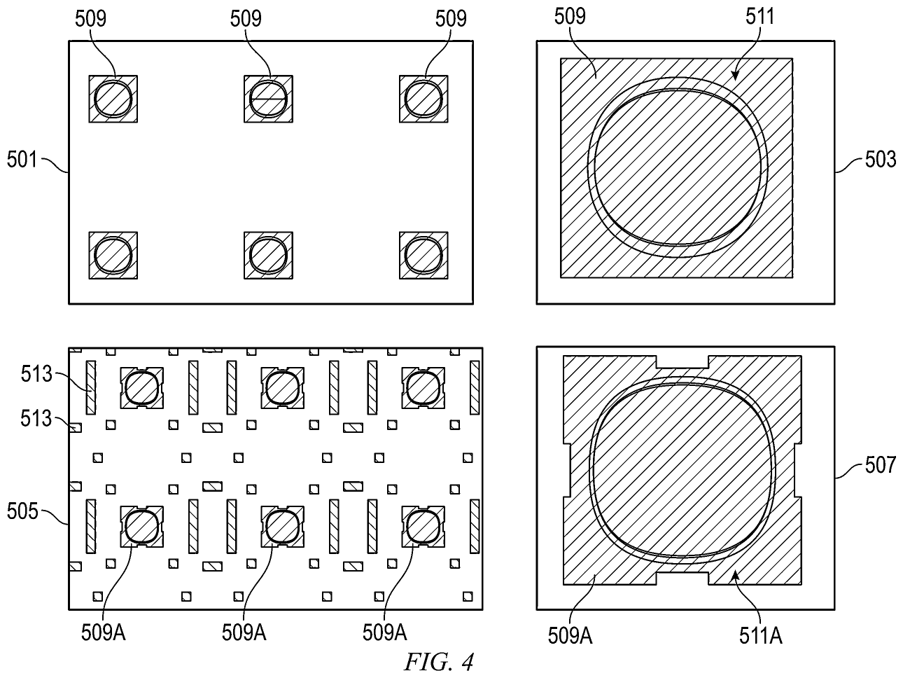

Referring to FIG. 4, via size variation can further be achieved by sub-resolution assistant feature (SRAF) placement. The sub-resolution assistant feature (SRAF) is typically applied to improve the patterns' process window and uniformity at the lithography stage. In the non-limiting example of FIG. 4, the pillar shape 2D structure's PVs (process variations) improved 60% with the same pillar size. SRAF can also broaden the CD distribution (which can be predicted by simulation, as will be appreciated by the skilled artisan). One or more embodiments broaden CD distribution by SRAF insertion in order to achieve the requirements for PUF. As will also be appreciated by the skilled artisan, an SRAF is applied to enhance the process window of isolated and semi-isolated features by taking advantage of the optical interference between the main features and the assistant features. View 501 shows a lithography photomask without SRAF. The mask includes a number of conventional features 509 (only the top three are numbered, to avoid clutter). View 503 shows a detail of one of the conventional features 509 including lithography contours 511. View 505 shows a mask with SRAF. The mask includes a number of conventional features 509A and the SRAF features 513 (to avoid clutter, only two of the SRAF features are numbered). View 507 shows a detail of one of the conventional features 509A including lithography contours 511A. It will be appreciated that in at least some cases, the same mask will be used to form the logic and PUF areas and a logic part of the mask will omit SRAF while a PUF part of the mask will include SRAF. Alternatively, the logic part could include different SRAF that do not prevent compliance with design rules and do not cause shorts/opens in the MIMCAPs.

It is worth noting that one or more prior art approaches use different modules in the PUF and logic regimes. That is, one or more prior-art approaches use elements such as fuses for the PUF region, which are not otherwise present in the functional (logic) portion of the circuit. In contrast, one or more embodiments use elements (e.g., MIMCAPs) present in the functional (logic) portion of the circuit t also implement the PUF region.

One or more embodiments are applicable for MIMCAP structures with multiple plates which require open areas to make via contacts to the middle plates. Such structures have only quite recently become available, for example, at the 14 nm node. In one or more embodiments, to make PUF and logic areas co-exist at the BEOL MIMCAP level, a careful and intentional feasibility study on the lithographic variability is performed, based on the teachings herein, yielding the resultant design space for plate and via dimensions.

Again, in one or more embodiments, the via size distribution and/or overlay distribution are different between the logic and PUF areas of the chip.

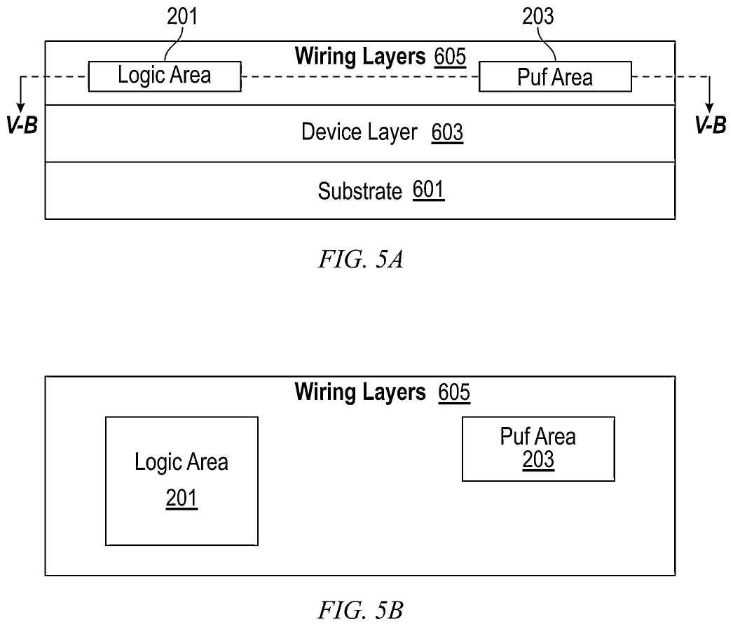

FIG. 5A is a side view of an integrated circuit, according to an aspect of the invention, while FIG. 5B is a plan view, along line section line V-B of FIG. 5A, according to an aspect of the invention. Note the substrate 601, device layer 603, and wiring layers 605 wherein logic area 201 and PUF area 203 are formed in a given one of the wiring layers. It can be seen in the plan view of FIG. 5B that the logic area 201 and PUF are 203 do not overlap. In one or more embodiments, there are no shorts/opens in area 201 (within the yield parameters) while there are deliberately introduced shorts and opens in PUF area 203.

Semiconductor device manufacturing includes various steps of device patterning processes. For example, the manufacturing of a semiconductor chip may start with, for example, a plurality of CAD (computer aided design) generated device patterns, which is then followed by effort to replicate these device patterns in a substrate. The replication process may involve the use of various exposing techniques and a variety of subtractive (etching) and/or additive (deposition) material processing procedures. For example, in a photolithographic process, a layer of photo-resist material may first be applied on top of a substrate, and then be exposed selectively according to a pre-determined device pattern or patterns. Portions of the photo-resist that are exposed to light or other ionizing radiation (e.g., ultraviolet, electron beams, X-rays, etc.) may experience some changes in their solubility to certain solutions. The photo-resist may then be developed in a developer solution, thereby removing the non-irradiated (in a negative resist) or irradiated (in a positive resist) portions of the resist layer, to create a photo-resist pattern or photo-mask. The photo-resist pattern or photo-mask may subsequently be copied or transferred to the substrate underneath the photo-resist pattern.

There are numerous techniques used by those skilled in the art to remove material at various stages of creating a semiconductor structure. As used herein, these processes are referred to generically as “etching”. For example, etching includes techniques of wet etching, dry etching, chemical oxide removal (COR) etching, and reactive ion etching (RIE), which are all known techniques to remove select material(s) when forming a semiconductor structure. The Standard Clean 1 (SC1) contains a strong base, typically ammonium hydroxide, and hydrogen peroxide. The SC2 contains a strong acid such as hydrochloric acid and hydrogen peroxide. The techniques and application of etching is well understood by those skilled in the art and, as such, a more detailed description of such processes is not presented herein.

Although the overall fabrication method and the structures formed thereby are novel, certain individual processing steps required to implement the method may utilize conventional semiconductor fabrication techniques and conventional semiconductor fabrication tooling. These techniques and tooling will already be familiar to one having ordinary skill in the relevant arts given the teachings herein. For example, the skilled artisan will be familiar with epitaxial growth, self-aligned contact formation, formation of high-K metal gates, and so on. As noted, the term “high-K” has a definite meaning to the skilled artisan in the context of high-K metal gate (HKMG) stacks, and is not a mere relative term. Moreover, one or more of the processing steps and tooling used to fabricate semiconductor devices are also described in a number of readily available publications, including, for example: James D. Plummer et al., Silicon VLSI Technology: Fundamentals, Practice, and Modeling 1^{st} Edition, Prentice Hall, 2001 and P. H. Holloway et al., Handbook of Compound Semiconductors: Growth, Processing, Characterization, and Devices, Cambridge University Press, 2008, which are both hereby incorporated by reference herein. It is emphasized that while some individual processing steps are set forth herein, those steps are merely illustrative, and one skilled in the art may be familiar with several equally suitable alternatives that would be applicable.

It is to be appreciated that the various layers and/or regions shown in the accompanying figures may not be drawn to scale. Furthermore, one or more semiconductor layers of a type commonly used in such integrated circuit devices may not be explicitly shown in a given figure for ease of explanation. This does not imply that the semiconductor layer(s) not explicitly shown are omitted in the actual integrated circuit device.

Given the discussion thus far, it will be appreciated that, in general terms, an exemplary integrated circuit includes a semiconductor substrate 601 and a logic (e.g., MIMCAP) area 201, located outward of the semiconductor substrate. The logic area includes a plurality of logic metal-insulator-metal decoupling capacitors; each of the logic metal-insulator-metal decoupling capacitors includes an upper logic area capacitor electrically conductive plate 101, a middle logic area capacitor electrically conductive plate 105, a lower logic area capacitor electrically conductive plate 103, an upper logic area capacitor dielectric region separating the upper logic area capacitor electrically conductive plate from the middle logic area capacitor electrically conductive plate (upper insulator 107) and a lower logic area capacitor dielectric region separating the middle logic area capacitor electrically conductive plate from the lower logic area capacitor electrically conductive plate (lower insulator 107). Each of the logic metal-insulator-metal decoupling capacitors further includes a top-bottom logic area capacitor electrical contact 109 electrically coupled to the upper logic area capacitor electrically conductive plate and the lower logic area capacitor electrically conductive plate, and electrically isolated from the middle logic area capacitor electrically conductive plate. Each of the logic metal-insulator-metal decoupling capacitors still further includes a middle logic area capacitor electrical contact 111 electrically coupled to the middle logic area capacitor electrically conductive plate and electrically isolated from the lower logic area capacitor electrically conductive plate and the upper logic area capacitor electrically conductive plate.

The exemplary integrated circuit also includes a physically unclonable function (PUF) area 203, located outward of the semiconductor substrate. The PUF area includes a plurality of PUF metal-insulator-metal capacitors. Each of the PUF metal-insulator-metal capacitors includes an upper PUF area electrically conductive plate 101A; a middle PUF area electrically conductive plate 105A; a lower PUF area electrically conductive plate 103A; an upper PUF area dielectric region separating the upper PUF area electrically conductive plate from the middle PUF area electrically conductive plate (upper insulator 107A); and a lower PUF area dielectric region separating the middle PUF area electrically conductive plate from the lower PUF area electrically conductive plate (lower insulator 107A).

Each of the PUF metal-insulator-metal capacitors includes a top-bottom PUF area electrical contact 109A and a middle PUF area electrical contact 111A. Nominally, the top-bottom PUF area capacitor electrical contact 109A is electrically coupled to the upper logic area capacitor electrically conductive plate and the lower logic area capacitor electrically conductive plate, and electrically isolated from the middle logic area capacitor electrically conductive plate. Nominally, each of the middle PUF area capacitor electrical contacts 111A is electrically coupled to the middle logic area capacitor electrically conductive plate and electrically isolated from the lower logic area capacitor electrically conductive plate and the upper logic area capacitor electrically conductive plate. However, in one or more embodiments, to produce the PUF, at least 10% of the PUF metal-insulator-metal capacitors and no more than 90% of the PUF metal-insulator-metal capacitors exhibit shorts.

It will be appreciated that in one or more embodiments, in a plan view such as FIG. 5B, the logic area 201 and the PUF area 203 are separate and do not overlap. In one or more embodiments, there are no shorts or opens in the MIMCAPs in the logic are 201, or the numbers of shorts and opens are within the yield limits; say, no more than 1% shorts/opens.

The shorts exhibited by the PUF metal-insulator-metal capacitors can include, for example: shorts of the top-bottom PUF area electrical contacts 109A to the middle PUF area electrically conductive plates 105A; shorts of the middle PUF area electrical contacts 111A to the upper PUF area electrically conductive plates 101A; or shorts of the middle PUF area electrical contacts 111A to the lower PUF area electrically conductive plates 103A.

In one or more embodiments, at least 10% of the PUF metal-insulator-metal capacitors and no more than 90% of the PUF metal-insulator-metal capacitors exhibit opens.

The opens exhibited by the PUF metal-insulator-metal capacitors can include, for example, opens of the top-bottom PUF area electrical contacts 109A to the upper PUF area electrically conductive plates 101A; opens of the top-bottom PUF area electrical contacts 109A to the lower PUF area electrically conductive plates 103A; or opens of the middle PUF area electrical contacts 111A to the middle PUF area electrically conductive plates 105A. “Nominal” connections refer to the connections as they would be without deliberately introducing opens/shorts; e.g., the middle contacts connect to the middle plate and are isolated from the upper and lower plates, while the upper/lower contacts connect to the upper and lower plates and are isolated from the middle plates. “Opens” refer to regions where nominal connections are not present, while “shorts” refer to regions where nominal isolation is not present to that nominally isolated conductors are connected.

In one or more embodiments, the top-bottom logic area capacitor electrical contacts 109 have a diameter standard deviation that is smaller than a diameter standard deviation of the top-bottom PUF area electrical contacts 109A, and the middle logic area capacitor electrical contacts 111 have a diameter standard deviation have that is smaller than a diameter standard deviation of the middle PUF area electrical contacts 111A.

In one or more embodiments, the integrated circuit further includes a plurality of devices (e.g., field effect transistors in device layer 603) formed on the substrate, and a plurality of (BEOL) wiring layers 605 outward of the plurality of devices. The plurality of logic metal-insulator-metal decoupling capacitors and the plurality of physically unclonable function metal-insulator-metal capacitors are located in the same one of the wiring layers (and can be formed simultaneously, for example).

In one or more embodiments, a pattern of the shorts and the opens encodes a unique PUF of the resulting IC.

In accordance with another aspect, an exemplary method includes obtaining a precursor semiconductor structure including a substrate 601, and a device layer 603 outside of the substrate. The method further includes obtaining a plurality of photomasks, including at least one via photomask with a logic area (see, e.g., 501) and a physically unclonable function (PUF) area (see, e.g., 505), wherein a logic via pattern in the logic area complies with design rules for a given technology node and a PUF via pattern in the PUF area violates design rules for the given technology node.

As an aside, it is worth noting that MIMCAPs in the logic area 201 will typically be connected with devices in the device layer 603 as part of the functionality of the IC (e.g., as decoupling capacitors), whereas MIMCAPs in the PUF area may be isolated from the other circuit elements and configured for PUF readout as a string of zeroes and ones.

Now continuing with the description of the exemplary method, one or more embodiments further include, using the plurality of photomasks, including the at least one via photomask, lithographically forming on the precursor semiconductor structure, in accordance with the given technology node: a logic area 201 and a PUF area 203. The logic area is formed at least in part using the logic area of the at least one via photomask and is located outward of the semiconductor substrate. The logic area includes a plurality of logic metal-insulator-metal decoupling capacitors, as described above. The PUF area is formed at least in part using the PUF area of the at least one via photomask and is located outward of the semiconductor substrate. The PUF area includes a plurality of PUF metal-insulator-metal capacitors, as described above.

In one or more embodiments, the logic area and PUF area are formed simultaneously at the same wiring level in the wiring layers 605 using different portions of the same lithography masks. For example, there may be different via to non-contacted electrode plate distances for the decoupling capacitor (logic) and PUF areas. In some cases, the via to non-contacted electrode distance follows the design rule of the technology node in the MIMCAP/logic area, while the via to non-contacted electrode distance is within the variation of via size in the PUF area (achieved using lithographic process-induced variability).

Again, in one or more embodiments, the logic/decoupling capacitor area follows the via enclosure rule for designs of via placement to one of the electrodes and the other electrode plates, while the PUF region deliberately violates the via enclosure rule to make the distance between the via and other electrode plates within the process variation. One or more embodiments use a via size close to the process limit for the PUF area while the standard via size is used in the decoupling capacitor area (more precisely, lithographic process conditions are optimized to introduce large variability in via size/shape in PUF area, but to still keep vias in the MIMCAP area uniform).

In one or more embodiments, obtaining the plurality of photomasks, including the at least one via photomask with the logic area and the physically unclonable function (PUF) area, includes obtaining the at least one via photomask with a plurality of sub-resolution assistant features (SRAFs) selected to increase process-induced variability in the PUF area, as discussed with respect to FIG. 4. It is to be emphasized that use of SRAFs is but one exemplary manner to obtain via size in a marginal region for purposes of deliberately introducing shorts and opens to serve as a PUF. Some embodiments use different SRAF placements in the MIMCAP/logic and PUF areas to make vias in the PUF area more susceptible to process-induced variability; for example, broadening critical dimension (CD) distribution by SRAF insertion in order to achieve the desired variability.

As an aside, it is worth noting that examples are presented in the context of capacitors with three plates and two dielectrics but capacitors with greater numbers of plates and dielectrics (e.g., by way of example and not limitation, five plates) can be used. Cases with three plates and two dielectrics will typically have at least two via masks, while cases with more plates and more dielectrics will typically have more via masks. In general, the randomness to cause opens and shorts can be included in any one, some, or all of the via masks.

The skilled person is familiar with the fabrication of MIMCAPs, and, given the teachings herein, can substitute one or more masks as described herein within conventional MIMCAP fabrication steps to obtain PUF MIMCAPs. Furthermore, the skilled person is familiar with the use of SRAFs, and, given the teachings herein, can design SRAFs for one or more masks as described herein to obtain PUF MIMCAPs.

In some cases, obtaining the plurality of photomasks, including the at least one via photomask with the logic area and the physically unclonable function (PUF) area, includes obtaining the at least one via photomask with the PUF area located to be more sensitive to overlay-induced variation than the logic area.

In some embodiments, the step of lithographically forming the logic area and the PUF area is carried out during back end of line (BEOL) processing, and, in the step of obtaining the precursor semiconductor structure, the precursor semiconductor structure has completed front end of line (FEOL) processing. BEOL and FEOL have defined meanings to the skilled artisan. The front-end-of-line (FEOL) is the first portion of IC fabrication where the individual devices (transistors, capacitors, resistors, etc.) are patterned in the semiconductor; FEOL generally covers everything up to (but not including) the deposition of metal interconnect layers. For the CMOS process, FEOL typically contains all fabrication steps needed to form fully isolated CMOS elements: selecting the type of wafer to be used; chemical-mechanical planarization and cleaning of the wafer; shallow trench isolation (STI), source, drain, and gate formation. The back end of line (BEOL) is the second portion of IC fabrication where the individual devices (transistors, capacitors, resistors, etc.) get interconnected with wiring on the wafer, the metallization layer.

In some cases, in the step of obtaining the precursor semiconductor structure, the precursor semiconductor structure is obtained by a second foundry from a first foundry, and the step of lithographically forming the logic area and the PUF area is carried out by the second foundry (the second foundry and/or its customers can then make use of the (BEOL) PUF).

In one or more embodiments, in the step of lithographically forming the logic area and the PUF area, at least 10% of the PUF metal-insulator-metal capacitors and no more than 90% of the PUF metal-insulator-metal capacitors exhibit opens, and a further step includes reading out the shorts and the opens as a pattern of zeroes and ones including a physically unclonable function (PUF). In one or more embodiments, opens (0) and shorts (1) occur randomly in the PUF area and a mixture of opens and shorts is obtained. The current can be measured (e.g., with a nano- or pico-ammeter probe) to detect opens as zeroes and shorts as ones, obtaining a unique sequence for each chip.

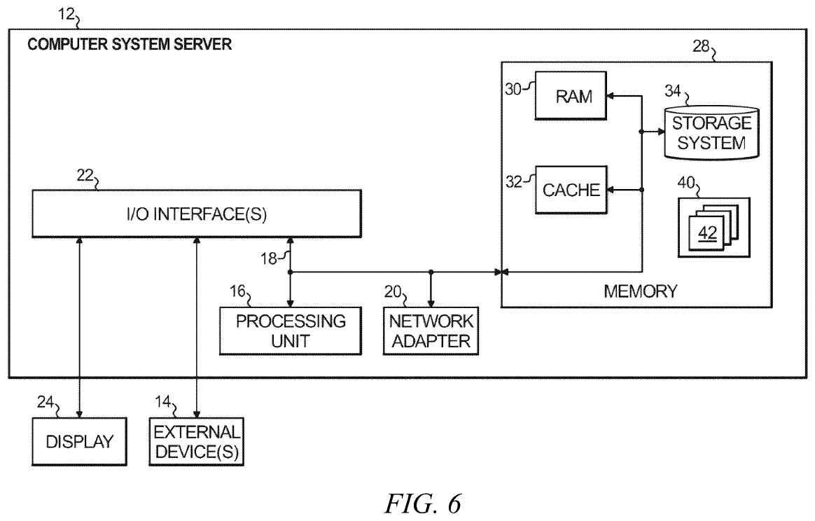

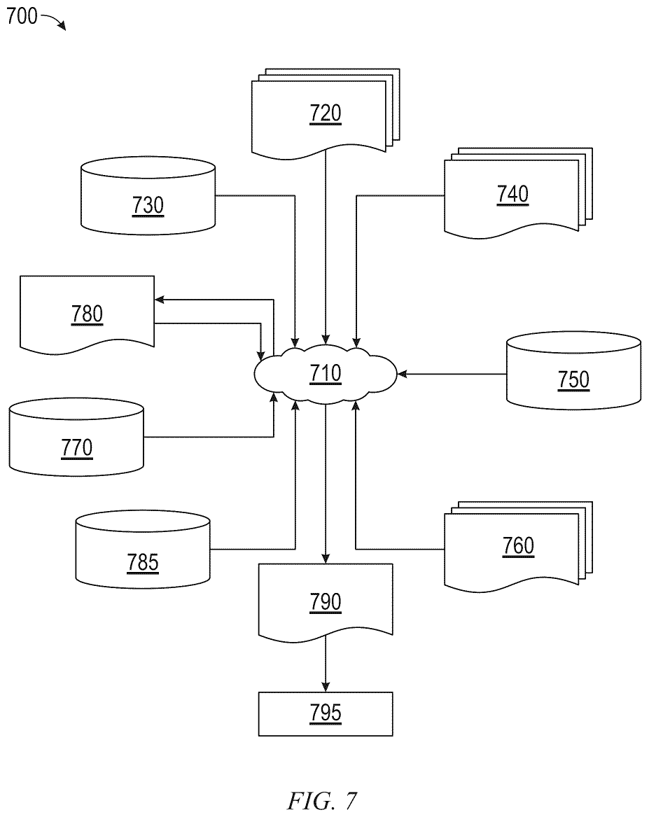

FIG. 6 depicts a computer system 12 that can be used, for example, to carry out a design process as described below with respect to FIG. 7. Computer system 12 includes, for example, one or more processors or processing units 16, a system memory 28, and a bus 18 that couples various system components including system memory 28 to processor 16. Element 16 can connect to the bus, for example, with suitable bus interface units.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below memory 28 may include at least one program product having a set (e.g., at least one) of program modules that are configured to carry out, e.g., a design process as shown in FIG. 7.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out software-implemented functions and/or methodologies.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Still with reference to FIG. 6, note processor 16, memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing desired tasks, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 6) running a server program. It will be understood that such a physical server may or may not include a display and keyboard. Furthermore, FIG. 6 is representative of a conventional general-purpose computer that could be used, for example, to implement aspects of the design process described below.

Exemplary Design Process Used in Semiconductor Design, Manufacture, and/or Test

One or more embodiments of hardware in accordance with aspects of the invention can be implemented using techniques for semiconductor integrated circuit design simulation, test, layout, and/or manufacture. In this regard, FIG. 7 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of design structures and/or devices, such as those disclosed herein or the like. The design structures processed and/or generated by design flow 700 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g., e-beam writers), computers or equipment for simulating design structures, any apparatus used in the manufacturing or test process, or any machines for programming functionally equivalent representations of the design structures into any medium (e.g., a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 7 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented by a core developer/designer. When encoded on a gate array or storage medium or the like, design structure 720 may be accessed and processed by one or more hardware and/or software modules within design process 710 to simulate or otherwise functionally represent an electronic component, circuit, electronic or logic module, apparatus, device, or system. As such, design structure 720 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher-level design languages such as C or C++.

Design process 710 preferably employs and incorporates hardware and/or software modules for synthesizing, translating, or otherwise processing a design/simulation functional equivalent of components, circuits, devices, or logic structures to generate a Netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 710 may include hardware and software modules for processing a variety of input data structure types including Netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g., information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on data storage media and that when processed by an ECAD system generate a logically or otherwise functionally equivalent form of one or more IC designs or the like as disclosed herein. In one embodiment, design structure 790 may comprise a compiled, executable HDL simulation model that functionally simulates the devices disclosed herein.

Design structure 790 may also employ a data format used for the exchange of layout data of integrated circuits and/or symbolic data format (e.g., information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein. Design structure 790 may then proceed to a stage 795 where, for example, design structure 790: proceeds to tape-out, is released to manufacturing, is released to a mask house, is sent to another design house, is sent back to the customer, etc.

Those skilled in the art will appreciate that the exemplary structures discussed above can be distributed in raw form (i.e., a single wafer having multiple unpackaged chips), as bare dies, in packaged form, or incorporated as parts of intermediate products or end products.

An integrated circuit in accordance with aspects of the present inventions can be employed in essentially any application and/or electronic system. Given the teachings of the present disclosure provided herein, one of ordinary skill in the art will be able to contemplate other implementations and applications of embodiments disclosed herein.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. An integrated circuit comprising:
a semiconductor substrate;
a logic area, located outward of the semiconductor substrate, the logic area including a plurality of logic metal-insulator-metal decoupling capacitors, each of the logic metal-insulator-metal decoupling capacitors comprising:
an upper logic area capacitor electrically conductive plate;
a middle logic area capacitor electrically conductive plate;
a lower logic area capacitor electrically conductive plate;
an upper logic area capacitor dielectric region separating the upper logic area capacitor electrically conductive plate from the middle logic area capacitor electrically conductive plate;
a lower logic area capacitor dielectric region separating the middle logic area capacitor electrically conductive plate from the lower logic area capacitor electrically conductive plate;
a top-bottom logic area capacitor electrical contact electrically coupled to the upper logic area capacitor electrically conductive plate and the lower logic area capacitor electrically conductive plate, and electrically isolated from the middle logic area capacitor electrically conductive plate; and
a middle logic area capacitor electrical contact electrically coupled to the middle logic area capacitor electrically conductive plate and electrically isolated from the lower logic area capacitor electrically conductive plate and the upper logic area capacitor electrically conductive plate; and
a physically unclonable function (PUF) area, located outward of the semiconductor substrate, the PUF area including a plurality of PUF metal-insulator-metal capacitors, each of the PUF metal-insulator-metal capacitors comprising:
an upper PUF area electrically conductive plate;
a middle PUF area electrically conductive plate;
a lower PUF area electrically conductive plate;
an upper PUF area dielectric region separating the upper PUF area electrically conductive plate from the middle PUF area electrically conductive plate;
a lower PUF area dielectric region separating the middle PUF area electrically conductive plate from the lower PUF area electrically conductive plate;
a top-bottom PUF area electrical contact; and
a middle PUF area electrical contact;
wherein at least 10% of the PUF metal-insulator-metal capacitors and no more than 90% of the PUF metal-insulator-metal capacitors exhibit shorts.

2. The integrated circuit of claim 1, wherein the shorts exhibited by the PUF metal-insulator-metal capacitors comprise shorts of the top-bottom PUF area electrical contacts to the middle PUF area electrically conductive plates.

3. The integrated circuit of claim 1, wherein the shorts exhibited by the PUF metal-insulator-metal capacitors comprise shorts of the middle PUF area electrical contacts to the upper PUF area electrically conductive plates.

4. The integrated circuit of claim 1, wherein the shorts exhibited by the PUF metal-insulator-metal capacitors comprise shorts of the middle PUF area electrical contacts to the lower PUF area electrically conductive plates.

5. The integrated circuit of claim 1, wherein at least 10% of the PUF metal-insulator-metal capacitors and no more than 90% of the PUF metal-insulator-metal capacitors exhibit opens.

6. The integrated circuit of claim 5, wherein the opens exhibited by the PUF metal-insulator-metal capacitors comprise opens of the top-bottom PUF area electrical contacts to the upper PUF area electrically conductive plates.

7. The integrated circuit of claim 5, wherein the opens exhibited by the PUF metal-insulator-metal capacitors comprise opens of the top-bottom PUF area electrical contacts to the lower PUF area electrically conductive plates.

8. The integrated circuit of claim 5, wherein the opens exhibited by the PUF metal-insulator-metal capacitors comprise opens of the middle PUF area electrical contacts to the middle PUF area electrically conductive plates.

9. The integrated circuit of claim 1, wherein:
the top-bottom logic area capacitor electrical contacts have a diameter standard deviation that is smaller than a diameter standard deviation of the top-bottom PUF area electrical contacts; and
the middle logic area capacitor electrical contacts have a diameter standard deviation have that is smaller than a diameter standard deviation of the middle PUF area electrical contacts.

10. The integrated circuit of claim 1, further comprising a plurality of devices formed on the substrate, and a plurality of wiring layers outward of the plurality of devices, wherein the plurality of logic metal-insulator-metal decoupling capacitors and the plurality of physically unclonable function metal-insulator-metal capacitors are located in a same one of the wiring layers.

11. A method comprising:
obtaining a precursor semiconductor structure comprising a substrate, and a device layer outside of the substrate;
obtaining a plurality of photomasks, including at least one via photomask with a logic area and a physically unclonable function (PUF) area, wherein a logic via pattern in the logic area complies with design rules for a given technology node and a PUF via pattern in the PUF area violates design rules for the given technology node;
using the plurality of photomasks, including the at least one via photomask, lithographically forming on the precursor semiconductor structure, in accordance with the given technology node:
a logic area, formed at least in part using the logic area of the at least one via photomask, and located outward of the semiconductor substrate, the logic area including a plurality of logic metal-insulator-metal decoupling capacitors, each of the logic metal-insulator-metal decoupling capacitors comprising:
an upper logic area capacitor electrically conductive plate;
a middle logic area capacitor electrically conductive plate;
a lower logic area capacitor electrically conductive plate;
an upper logic area capacitor dielectric region separating the upper logic area capacitor electrically conductive plate from the middle logic area capacitor electrically conductive plate;
a lower logic area capacitor dielectric region separating the middle logic area capacitor electrically conductive plate from the lower logic area capacitor electrically conductive plate;
a top-bottom logic area capacitor electrical contact electrically coupled to the upper logic area capacitor electrically conductive plate and the lower logic area capacitor electrically conductive plate, and electrically isolated from the middle logic area capacitor electrically conductive plate; and
a middle logic area capacitor electrical contact electrically coupled to the middle logic area capacitor electrically conductive plate and electrically isolated from the lower logic area capacitor electrically conductive plate and the upper logic area capacitor electrically conductive plate; and
a physically unclonable function (PUF) area, formed at least in part using the PUF area of the at least one via photomask, located outward of the semiconductor substrate, the PUF area including a plurality of PUF metal-insulator-metal capacitors, each of the PUF metal-insulator-metal capacitors comprising:
an upper PUF area electrically conductive plate;
a middle PUF area electrically conductive plate;
a lower PUF area electrically conductive plate;
an upper PUF area dielectric region separating the upper PUF area electrically conductive plate from the middle PUF area electrically conductive plate;
a lower PUF area dielectric region separating the middle PUF area electrically conductive plate from the lower PUF area electrically conductive plate;
a top-bottom PUF area electrical contact; and
a middle PUF area electrical contact;
wherein at least 10% of the PUF metal-insulator-metal capacitors and no more than 90% of the PUF metal-insulator-metal capacitors exhibit shorts.

12. The method of claim 11, wherein obtaining the plurality of photomasks, including the at least one via photomask with the logic area and the physically unclonable function (PUF) area, includes obtaining the at least one via photomask with a plurality of sub-resolution assistant features (SRAFs) selected to increase process-induced variability in the PUF area.

13. The method of claim 11, wherein obtaining the plurality of photomasks, including the at least one via photomask with the logic area and the physically unclonable function (PUF) area, includes obtaining the at least one via photomask with the PUF area located to be more sensitive to overlay-induced variation than the logic area.

14. The method of claim 11, wherein the step of lithographically forming the logic area and the PUF area is carried out during back end of line (BEOL) processing, and wherein, in the step of obtaining the precursor semiconductor structure, the precursor semiconductor structure has completed front end of line (FEOL) processing.

15. The method of claim 14, wherein, in the step of obtaining the precursor semiconductor structure, the precursor semiconductor structure is obtained by a second foundry from a first foundry, and wherein the step of lithographically forming the logic area and the PUF area is carried out by the second foundry.

16. The method of claim 11, wherein, in the step of lithographically forming the logic area and the PUF area, at least 10% of the PUF metal-insulator-metal capacitors and no more than 90% of the PUF metal-insulator-metal capacitors exhibit opens, further comprising reading out the shorts and the opens as a pattern of zeroes and ones comprising a physically unclonable function (PUF).

17. A hardware description language (HDL) design structure encoded on a machine-readable data storage medium, the HDL design structure comprising elements that when processed in a computer-aided design system generates a machine-executable representation of an integrated circuit, wherein the HDL design structure comprises:
a semiconductor substrate;
a logic area, located outward of the semiconductor substrate, the logic area including a plurality of logic metal-insulator-metal decoupling capacitors, each of the logic metal-insulator-metal decoupling capacitors comprising:
an upper logic area capacitor electrically conductive plate;
a middle logic area capacitor electrically conductive plate;
a lower logic area capacitor electrically conductive plate;
an upper logic area capacitor dielectric region separating the upper logic area capacitor electrically conductive plate from the middle logic area capacitor electrically conductive plate;
a lower logic area capacitor dielectric region separating the middle logic area capacitor electrically conductive plate from the lower logic area capacitor electrically conductive plate;
a top-bottom logic area capacitor electrical contact electrically coupled to the upper logic area capacitor electrically conductive plate and the lower logic area capacitor electrically conductive plate, and electrically isolated from the middle logic area capacitor electrically conductive plate; and
a middle logic area capacitor electrical contact electrically coupled to the middle logic area capacitor electrically conductive plate and electrically isolated from the lower logic area capacitor electrically conductive plate and the upper logic area capacitor electrically conductive plate; and
a physically unclonable function (PUF) area, located outward of the semiconductor substrate, the PUF area including a plurality of PUF metal-insulator-metal capacitors, each of the PUF metal-insulator-metal capacitors comprising:
an upper PUF area electrically conductive plate;
a middle PUF area electrically conductive plate;
a lower PUF area electrically conductive plate;
an upper PUF area dielectric region separating the upper PUF area electrically conductive plate from the middle PUF area electrically conductive plate;
a lower PUF area dielectric region separating the middle PUF area electrically conductive plate from the lower PUF area electrically conductive plate;
a top-bottom PUF area electrical contact; and
a middle PUF area electrical contact;
wherein at least 10% of the PUF metal-insulator-metal capacitors and no more than 90% of the PUF metal-insulator-metal capacitors exhibit shorts.

18. The design structure of claim 17, wherein at least 10% of the PUF metal-insulator-metal capacitors and no more than 90% of the PUF metal-insulator-metal capacitors exhibit opens.

19. The design structure of claim 17, wherein:
the top-bottom logic area capacitor electrical contacts have a diameter standard deviation that is smaller than a diameter standard deviation of the top-bottom PUF area electrical contacts; and
the middle logic area capacitor electrical contacts have a diameter standard deviation have that is smaller than a diameter standard deviation of the middle PUF area electrical contacts.

20. The design structure of claim 17, further comprising a plurality of devices formed on the substrate, and a plurality of wiring layers outward of the plurality of devices, wherein the plurality of logic metal-insulator-metal decoupling capacitors and the plurality of physically unclonable function metal-insulator-metal capacitors are located in a same one of the wiring layers.
